(19) United States
(12) Patent Application Publication
(10) Pub. No.: US 2024/0271028 A1
(43) Pub. Date: Aug. 15, 2024

(54) METHODS FOR PREVENTING OR MITIGATING WELLBORE SCREEN OUT CONDITIONS USING ACID BLENDS

(71) Applicant: ExxonMobil Technology and Engineering Company, Spring, TX (US)

(72) Inventors: Robert M. SHIRLEY, The Woodlands, TX (US); P. Matthew SPIECKER, Manvel, TX (US); Lee J. HALL, The Woodlands, TX (US)

(21) Appl. No.: 18/567,675

(22) PCT Filed: Apr. 5, 2022
(86) PCT No.: PCT/US2022/071532

§ 371 Date: Dec. 6, 2023

Related U.S. Application Data
(60) Provisional application No. 63/208,214, filed on Jun. 8, 2021.

(51) Int. Cl. C09K 8/528; C09K 8/74; E21B 43/267; E21B 43/27

(52) U.S. Cl. CPC C09K 8/528; C09K 8/74; E21B 43/267; E21B 43/27

(57) ABSTRACT

Methods for utilizing an acid blend to prevent and/or remove blockages encountered during the hydraulic fracturing of a near-wellbore region of a subterranean formation are provided herein. The methods include using an acid blend to dissolve formation mineralogies within close proximity to perforations and corresponding fractures that have experienced or are likely to experience blockages, such as blockages caused by the embedment of proppant into the perforation tunnels and/or the fractures. The acid blend used according to the methods described herein includes an acid mixture including hydrochloric acid and hydrofluoric acid. In addition, the acid blend may also include a chelating agent.

### CROSS-REFERENCE TO RELATED APPLICATION

This application is the U.S. National Stage Application of the International Application No. PCT/US2022/071532, entitled “METHODS FOR PREVENTING OR MITIGATING WELLBORE SCREEN OUT CONDITIONS USING ACID BLENDS,” filed on Apr. 5, 2022, the disclosure of which is hereby incorporated by reference in its entirety, which claims priority to and the benefit of U.S. Provisional Application No. 63/208,214 having a filing date of Jun. 8, 2021, the disclosure of which is incorporated herein by reference in its entirety.

### FIELD OF THE INVENTION

The techniques described herein relate to the hydrocarbon production field. More particularly, the techniques described herein relate to methods for utilizing a novel acid blend to prevent and/or mitigate wellbore screen out conditions.

### BACKGROUND OF THE INVENTION

This section is intended to introduce various aspects of the art, which may be associated with embodiments of the present techniques. This discussion is believed to assist in providing a framework to facilitate a better understanding of particular aspects of the present techniques. Accordingly, it should be understood that this section should be read in this light, and not necessarily as admissions of prior art.

During a hydrocarbon production operation, a wellbore is drilled into a subterranean formation to promote the removal (or production) of hydrocarbon fluids from the formation. For many wellbores (such as, in particular, wellbores corresponding to low-permeability or “tight” subterrancan formations), hydraulic fracturing is also performed to prepare the wellbore and the surrounding formation for production. Such hydraulic fracturing involves pumping large quantities of a fracturing fluid (e.g. slickwater) into the formation under high hydraulic pressure to promote the formation of fractures within the matrix of the formation and to create high-hydraulic-conductivity flow paths for the production of the hydrocarbon fluids from the formation. Once the fracturing fluid has created the fractures within the subterranean formation, a slurry of fracturing fluid including a proppant (e.g., sand and/or ceramics) is typically pumped into the formed fractures such that the proppant “props” or holds open the fractures once the hydraulic pressure has been released. In this manner, the proppant provides a long-term increase in fluid permeability within the near-wellbore region of the formation.

Ultimately, the size (e.g., length and width) of the fractures formed during hydraulic fracturing is a key control on the amount of hydrocarbon fluids that can ultimately be produced from the formation via the hydrocarbon well. In addition, the size of the fractures is generally dependent on the amount of fracturing fluid that can be successfully pumped into such fractures. As a result, if difficulties are encountered during hydraulic fracturing such that the full volume of fracturing fluid cannot be pumped into the fractures or the fracturing fluid cannot be pumped at a high enough rate, production from the fractures can be very negatively impacted. Moreover, such difficulties are often encountered as proppant deposits (or settles) within the fractures, thus limiting the effective reach and/or depth to which the proppant can be utilized. This, in turn, may result in a screen out condition, in which the deposited proppant restricts fluid flow into the fractures such that continued injection of the fracturing fluid would require injection pressures in excess of the safe limitations of the wellbore and/or associated wellhead equipment. Furthermore, while screen out mitigation techniques do exist, such techniques have limited success.

### SUMMARY OF THE INVENTION

An embodiment described herein provides a method for utilizing an acid blend for removing a blockage encountered during hydraulic fracturing of a near-wellbore region of a subterranean formation. The method includes injecting a slurry of fracturing fluid and proppant into a wellbore via a tubular such that the slurry flows through a perforation within the tubular and into a corresponding fracture within a subterranean formation, as well as detecting an increase in the injection pressure for injecting the slurry into the wellbore via the tubular. The method includes, in response to detecting the increase in the injection pressure, determining that a blockage has occurred within the perforation and/or the corresponding fracture and, in response to determining that the blockage has occurred, discontinuing the injection of the slurry into the wellbore. The method also includes injecting an acid blend into the wellbore via the tubular. The acid blend includes an acid mixture including hydrochloric acid and hydrofluoric acid, where the hydrochloric acid comprises at least 5 weight percent (wt %) and at most 35 wt % of the acid blend and the hydrofluoric acid comprises at least 2 wt % and at most 12 wt % of the acid blend. In addition, the acid blend may (optionally) include a chelating agent that is selected to decrease a potential for precipitation of metal ion complexes from the acid blend upon reaction of the acid blend with formation mineralogies within the subterranean formation, as well as to decrease a reaction rate of the acid mixture with the formation mineralogies. The method further includes dissolving, via the acid mixture of the acid blend, formation mineralogies within close proximity to the perforation and/or the corresponding fracture that has experienced the blockage, as well as (optionally) chelating, via the chelating agent of the acid blend, polyvalent metal ions released during the dissolution of the formation mineralogies to decrease the potential for precipitation of metal ion complexes including the polyvalent metal ions.

Another embodiment described herein provides a method for utilizing an acid blend to prevent a blockage during hydraulic fracturing of a near-wellbore region of a subterranean formation. The method includes perforating a tubular of a wellbore and injecting an acid blend into the wellbore via the tubular. The acid blend includes an acid mixture including hydrochloric acid and hydrofluoric acid, where the hydrochloric acid comprises at least 5 wt % and at most 35 wt % of the acid blend and the hydrofluoric acid comprises at least 2 wt % and at most 12 wt % of the acid blend. In addition, the acid blend may (optionally) include a chelating agent that is selected to decrease a potential for precipitation of metal ion complexes from the acid blend upon reaction of the acid blend with formation mineralogies within a subterranean formation, as well as to decrease a reaction rate of the acid mixture with the formation mineralogies. The method also includes dissolving, via the acid mixture of the acid blend, formation mineralogies of the subterranean formation that are within close proximity to the perforation within the tubular, as well as (optionally) chelating, via the chelating agent of the acid blend, polyvalent metal ions released during the dissolution of the formation mineralogies to decrease the potential for precipitation of metal ion complexes including the polyvalent metal ions.

These and other features and attributes of the disclosed embodiments of the present disclosure and their advantageous applications and/or uses will be apparent from the detailed description which follows.

### BRIEF DESCRIPTION OF THE DRAWINGS

To assist those of ordinary skill in the relevant art in making and using the subject matter thereof, reference is made to the appended drawings.

FIG. 1 is a schematic view of an exemplary hydrocarbon well for which an acid blend may be used for screen out mitigation according to embodiments described herein.

FIG. 2 is a schematic view of an exemplary hydrocarbon well for which an acid blend may be used for screen out prevention according to embodiments described herein.

FIG. 3 is a graph showing the percentage of rock dissolved during acid digestion experiments as a function of time for several formulations of the acid blend.

FIG. 4 is a graph showing the normalized weight percent of the precipitate developed during the acid digestion experiments as a function of time for several formulations of the acid blend.

FIG. 5 is a process flow diagram of a method for utilizing an acid blend to remove a blockage encountered during hydraulic fracturing of a near-wellbore region of a subterranean formation according to embodiments described herein.

FIG. 6 is a process flow diagram of a method for utilizing an acid blend to prevent a blockage during hydraulic fracturing of a near-wellbore region of a subterranean formation according to embodiments described herein.

It should be noted that the figures are merely examples of the present techniques and are not intended to impose limitations on the scope of the present techniques. Further, the figures are generally not drawn to scale, but are drafted for purposes of convenience and clarity in illustrating various aspects of the techniques.

### DETAILED DESCRIPTION OF THE INVENTION

In the following detailed description section, the specific examples of the present techniques are described in connection with preferred embodiments. However, to the extent that the following description is specific to a particular embodiment or a particular use of the present techniques, this is intended to be for example purposes only and simply provides a description of the embodiments. Accordingly, the techniques are not limited to the specific embodiments described below, but rather, include all alternatives, modifications, and equivalents falling within the true spirit and scope of the appended claims.

### Definitions

At the outset, and for case of reference, certain terms used in this application and their meanings as used in this context are set forth. To the extent a term used herein is not defined below, it should be given the broadest definition persons in the pertinent art have given that term as reflected in at least one printed publication or issued patent. Further, the present techniques are not limited by the usage of the terms shown below, as all equivalents, synonyms, new developments, and terms or techniques that serve the same or a similar purpose are considered to be within the scope of the present claims.

As used herein, the terms “a” and “an” mean one or more when applied to any embodiment described herein. The use of “a” and “an” does not limit the meaning to a single feature unless such a limit is specifically stated.

The terms “about” and “around” mean a relative amount of a material or characteristic that is sufficient to provide the intended effect. The exact degree of deviation allowable in some cases may depend on the specific context, e.g., +1%, +5%, +10%, +15%, etc. It should be understood by those of skill in the art that these terms are intended to allow a description of certain features described and claimed without restricting the scope of these features to the precise numerical ranges provided. Accordingly, these terms should be interpreted as indicating that insubstantial or inconsequential modifications or alterations of the subject matter described are considered to be within the scope of the disclosure.

The term “and/or” placed between a first entity and a second entity means one of: (1) the first entity; (2) the second entity; and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “including,” may refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

As used herein, the term “any” means one, some, or all of a specified entity or group of entities, indiscriminately of the quantity.

The phrase “at least one,” in reference to a list of one or more entities, should be understood to mean at least one entity selected from any one or more of the entities in the list of entities, but not necessarily including at least one of each and every entity specifically listed within the list of entities, and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently, “at least one of A and/or B”) may refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” may mean A alone, B alone, C alone, A and B together, A and C together, B and C together, A, B, and C together, and optionally any of the above in combination with at least one other entity.

As used herein, the phrase “based on” does not mean “based only on,” unless expressly specified otherwise. In other words, the phrase “based on” means “based only on,” “based at least on,” and/or “based at least in part on.”

As used herein, the term “configured,” when used in reference to a given element, component, or other subject matter, means that the element, component, or other subject matter is designed and/or intended to perform a given function. Thus, the use of the term “configured” should not be construed to mean that the element, component, or other subject matter is simply “capable of” performing a given function but that the element, component, and/or other subject matter is specifically selected, created, implemented, utilized, and/or designed for the purpose of performing the function.

As used herein, the terms “example,” exemplary,” and “embodiment,” when used with reference to one or more components, features, structures, and/or methods according to the present techniques, are intended to convey that the described component(s), feature(s), structure(s), and/or method(s) are illustrative, non-exclusive examples of component(s), feature(s), structure(s), and/or method(s) according to the present techniques. Thus, the described component(s), feature(s), structure(s), and/or method(s) are not intended to be limiting, required, or exclusive/exhaustive; and other component(s), feature(s), structure(s), and/or method(s), including structurally and/or functionally similar and/or equivalent component(s), feature(s), structure(s), and/or method(s), are also within the scope of the present techniques.

As used herein, the term “fluid” may refer to gases, liquids, combinations of gases and liquids, combinations of gases and solids, combinations of liquids and solids, and/or combinations of gases, liquids, and solids.

The term “fracturing fluid” refers to a fluid injected into a hydrocarbon well as part of a stimulation operation. A commonly-used fracturing fluid is “slickwater.” Slickwater is mostly water with a small amount, i.e., around 1%, of friction reducers and other viscous fluids (usually shear thinning, non-Newtonian gels or emulsions). The friction reducers and viscous fluids allow for a faster pumping rate into a reservoir, leading to an increase in the numbers and sizes of the fractures formed.

As used herein, the term “hydraulic conductivity” refers to the ability of a fluid within a formation to pass through a fracture including proppant at various stress (or pressure) levels, which is based, at least in part, on the permeability of the proppant deposited within the fractures.

The term “hydraulic fracturing” refers to a process for creating fractures that extend from a wellbore into a formation, so as to stimulate the flow of hydrocarbon fluids from the formation into the wellbore. A fracturing fluid is generally injected into the reservoir with sufficient pressure to create and extend multiple fractures within the reservoir, and a proppant is used to “prop” or hold open the fractures after the hydraulic pressure used to generate the fractures has been released.

A “hydrocarbon” is an organic compound that primarily includes the elements hydrogen and carbon, although nitrogen, sulfur, oxygen, metals, or any number of other elements may be present in small amounts. As used herein, the term “hydrocarbon” generally refers to components found in natural gas, oil, or chemical processing facilities. Moreover, the term “hydrocarbon” may refer to components found in raw natural gas, such as CH₄, C₂H₆, C₃ isomers, C₄ isomers, benzene, and the like.

As used herein, the term “permeability” refers to the capacity of a material to allow fluids to pass through it. Permeability may be measured using Darcy's Law: Q=(k ΔP A)/(μL), where Q=flow rate (cm³/s), ΔP=pressure drop (atm) across a cylinder having a length L (cm) and a cross-sectional area A (cm²), μ=fluid viscosity (cp), and k=permeability (Darcy). The customary unit of measurement for permeability is the millidarcy (mD). When the term “permeability” is used herein with reference to a formation, or an interval of a formation, it refers to the capacity of the formation to transmit fluids through the interconnected pore spaces of the rock.

As used herein, the term “pill” refers to a fluid volume that is smaller than that used to hydraulically fracture a well. For example, a pill may be a relatively-small fluid volume of around 100 to around 1,000 gallons.

The term “pressure” refers to a force acting on a unit area. Pressure is usually shown as pounds per square inch (psi).

As used herein, the term “proppant” refers to particles that are mixed with fracturing fluid to hold open fractures that are formed within a near-wellbore region of a reservoir using a hydraulic fracturing process. The size, shape, strength, and density of the proppant material have a significant impact on the hydraulic fracturing process. Currently, commercial proppant materials include natural proppants, such as natural sands, resin-coated natural sands, shell fragments, and the like, and artificial proppants, such as sintered bauxite and ceramics, resin-coated ceramics, lightweight proppants, ultra-lightweight proppants, and the like.

As used herein, the term “screen out” refers to a condition in which proppant deposited within fractures corresponding to a wellbore restricts fluid flow into the fractures such that continued injection of the fracturing fluid would require injection pressures in excess of the safe limitations of the wellbore and/or associated wellhead equipment.

The term “substantially,” when used in reference to a quantity or amount of a material, or a specific characteristic thereof, refers to an amount that is sufficient to provide an effect that the material or characteristic was intended to provide. The exact degree of deviation allowable may depend, in some cases, on the specific context.

The term “subterranean formation” (or simply “formation”) refers to a subsurface region including an aggregation of subsurface sedimentary, metamorphic and/or igneous matter, whether consolidated or unconsolidated, and other subsurface matter, whether in a solid, semi-solid, liquid and/or gaseous state, related to the geological development of the subsurface region. A formation can be a body of geologic strata of predominantly one type of rock or a combination of types of rock, or a fraction of strata having substantially common sets of characteristics. A formation can contain one or more hydrocarbon-bearing intervals, generally referred to as “reservoirs.”

The terms “wellbore” refers to a hole within a subterranean formation that is drilled vertically, at least in part, optionally with deviated, highly deviated, and/or lateral sections. The term “wellbore” also includes the surface casing string, intermediate casing string(s), production casing string, and other associated downhole equipment. Relatedly, the term “hydrocarbon well” refers to the wellbore in combination with the wellhead and other surface equipment that is typically associated with hydrocarbon production operations.

Certain aspects and features are described herein using a set of numerical upper limits and a set of numerical lower limits. It should be appreciated that ranges from any lower limit to any upper limit are contemplated unless otherwise indicated. All numerical values are “about” or “approximately” the indicated value, and account for experimental errors and variations that would be expected by those skilled in the art.

Furthermore, concentrations, dimensions, amounts, and/or other numerical data that are presented in a range format are to be interpreted flexibly to include not only the numerical values explicitly recited as the limits of the range, but also all individual numerical values or sub-ranges encompassed within that range, as if each numerical value and sub-range were explicitly recited. For example, a disclosed numerical range of 1 to 200 should be interpreted to include, not only the explicitly-recited limits of 1 and 200, but also individual values, such as 2, 3, 4, 197, 198, 199, etc., as well as sub-ranges, such as 10 to 50, 20 to 100, etc. Similarly, it should be understood that, when numerical ranges are provided, such ranges are to be construed as providing literal support for claim limitations that only recite the lower value of the range, as well as claim limitations that only recite the upper value of the range. For example, a disclosed numerical range of 10 to 100 provides literal support for a claim reciting “greater than 10” (with no upper bound) and a claim reciting “less than 100” (with no lower bound).

The size (e.g., length and width) of the fractures formed during hydraulic fracturing is a key control on the amount of hydrocarbon fluids that can ultimately be produced from the formation via the hydrocarbon well. In addition, the size of the fractures is generally dependent on the amount of fracturing fluid that is successfully pumped into such fractures. As a result, if difficulties are encountered during hydraulic fracturing such that the full volume of fracturing fluid cannot be pumped into the fractures or the fracturing fluid cannot be pumped at a high enough rate, production from the fractures can be very negatively impacted. In addition, flow rates through the generated fracture network are rate-limited by the matrix permeabilities around the fractures, which are typically much lower than 1 millidarcy (mD). As a result, any loss of fracture conductivity by proppant embedment into the formation or fracture healing or pinch out has a significant impact on the well productivity due to the lack of matrix pressure support. This is a common problem that affects many wells for unconventional formations. Moreover, this often results in the occurrence of a wellbore screen out condition, at which point additional proppant cannot be effectively pumped into the wellbore due to blockages within close proximity to the perforations (e.g., often within the first few feet of the corresponding fractures) or within the perforation tunnels themselves.

Currently, one of the main approaches to solving this issue is to cease pumping the slurry of fracturing fluid and proppant, pump a pill of hydrochloric acid into the affected stage of the wellbore to dissolve the blockage, and then resume pumping the slurry. However, this operation has very limited success, especially with respect to unconventional formations. In general, the use of hydrochloric acid is restricted to formations with high carbonate content since the use of hydrochloric acid for formations with other mineralogy types can result in the precipitation of mineral scale, asphaltenes, and possibly other forms of metal ion complexes from the acid solution. These solids then deposit within the fractures and, as a result, limit and/or block fluid flow through the fractures.

Accordingly, embodiments described herein provide methods for preventing and/or mitigating such wellbore screen out conditions using a novel acid blend, optionally with chelating properties. More specifically, for screen out prevention, the acid blend is pumped into the wellbore ahead of the pad of fracturing fluid and allowed to react with the near-wellbore region of the formation such that the widths of the perforations are increased and the near-wellbore region of the formation is prepared for hydraulic fracturing. Similarly, for screen out mitigation, the acid blend is injected into the near-wellbore region of the formation as a pill while pumping of the slurry is halted and then allowed to react with the near-wellbore region of the formation such that blockages near and/or within the perforations are dissolved to enable additional proppant to be placed within the corresponding fractures.

According to embodiments described herein, the acid blend includes a novel acid mixture and may also include a chelating agent. The acid mixture is a combination of hydrochloric acid and hydrofluoric acid, with a hydrofluoric acid concentration of 2 weight percent (wt %) or more. In addition, the chelating agent may be used to prevent dissolved components (such as, for example, aluminum hydroxides and calcium fluoride) from precipitating out of solution during a wellbore shut-in or flowback period, for example. Moreover, in various embodiments, the acid blend is delivered as two different mixtures that are safe for handling and then mixed together to produce an active acid mixture.

The acid blend described herein is capable of dissolving most mineralogies (e.g., carbonates, clays, quartz, and/or sand or other proppants) encountered in most unconventional formations. In particular, the acid blend is effective at partially dissolving the fracture faces, providing rugose fracture surfaces with baffles that increase the hydraulic conductivity within the fractures. Furthermore, as a result of the acid blend's ability to dissolve almost any mineralogy it contacts within the formation, the acid blend is effective at removing near-wellbore blockages, such as blockages within or near the perforation tunnels, thus enabling the slurry of fracturing fluid and proppant to be pumped at target rates.

### Exemplary Hydrocarbon Wells for Which Acid Blend Described Herein May be Utilized

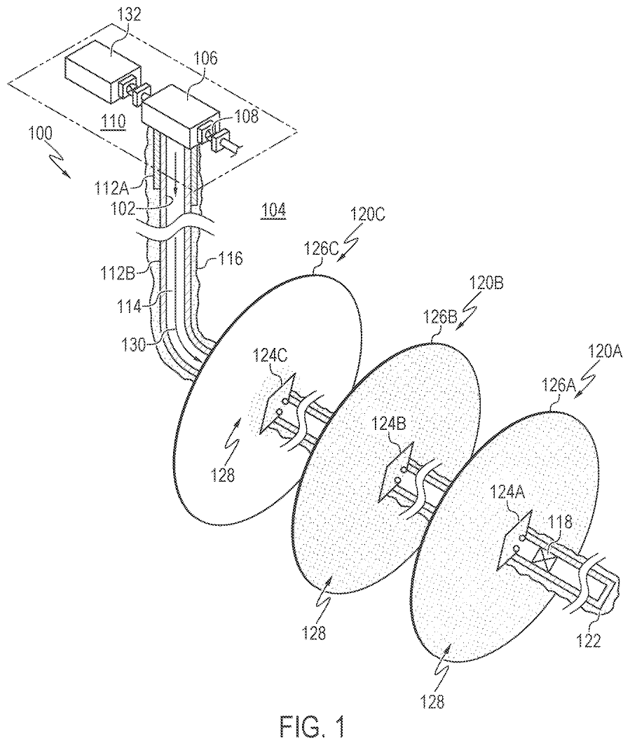

FIG. 1 is a schematic view of an exemplary hydrocarbon well 100 for which an acid blend may be used for screen out mitigation according to embodiments described herein. The exemplary hydrocarbon well 100 includes a wellbore 102 that extends within a subsurface region 104 including a hydrocarbon-bearing subterranean formation (or reservoir). In various embodiments, the subterranean formation is an unconventional formation, such as a formation including, but not limited to, tight sandstone, shale, clay-rich mudstone, sand-rich mudstone, carbonate, and/or siliciclastic mudstone. The hydrocarbon well 100 also includes a wellhead 106 including (among other components) a shut-in valve 108 that controls the flow of hydrocarbon fluids from the subsurface region 104 to a surface region 110.

The hydrocarbon well 100 is completed by setting a series of tubulars into the wellbore 102. These tubulars include several strings of casing, such as a surface casing string 112A and a production casing string 112B, as shown in FIG. 1, which define a tubular conduit 114 that provides a flow path for the hydrocarbons fluid to flow from the subsurface region 104 to the surface region 110. In some embodiments, additional intermediate casing strings (not shown) are also included to provide support for the walls of the wellbore 102. According to the embodiment shown in FIG. 1, the surface casing string 112A and the production casing string 112B are both hung from the surface. However, in some embodiments, the surface casing string 112A is hung from the surface, while the production casing string 112B (sometimes referred to as a “production liner”) is hung from the bottom of a preceding casing string (e.g., an intermediate casing string) using a liner hanger (not shown).

In various embodiments, the surface casing string 112A and the production casing string 112B (as well any intermediate casing strings) are set in place using cement 116. The cement 116 isolates the intervals of the subterranean formation from the wellbore 102 and each other. Alternatively, the wellbore 102 is set as an open-hole completion, meaning that the production casing string 112B (or production liner) is not set in place using cement.

In some embodiments, the subterranean formation surrounding the wellbore 102 is hydraulically fractured via a plug-and-perforation (or “plug-and-perf”) process (or other suitable multistage hydraulic fracturing process). To implement this plug-and-perf process, a bottomhole assembly (BHA) (not shown) including perforating guns (not shown), a fracturing plug (or “frac plug”) 118, and a setting tool (not shown) is run to a desired depth or zone within the wellbore 102, where the desired depth or zone corresponds to a specific stage 120A, 120B, or 120C of the hydrocarbon well 100. Once the desired depth or zone is reached, the setting tool is used to set the frac plug 118 against the inner diameter of the production casing string 112B, as shown with respect to the first stage 120A (i.e., the stage closest to a toe 122 of the wellbore 102 in FIG. 1). Moreover, once the frac plug 118 has been set within the production casing string 112B, the perforating guns are detonated to create a cluster of perforations 124A through the production casing string 112B and the surrounding cement 116. The plug-and-perf assembly is then removed from the wellbore 102, and fracturing fluid is pumped down the wellbore 102, through the cluster of perforations 124A, and into the surrounding formation, forming fractures 126A in the reservoir 114. Moreover, a slurry of fracturing fluid and proppant 128, such as sand, crushed granite, ceramic beads, or other granular materials, is pumped down the wellbore 102 such that the proppant 128 is positioned within at least a portion of each fracture 126A, with the effective reach and/or depth of the proppant 128 varying based on the conditions within the fractures. In this manner, the proppant 128 serves to hold the fractures 126A open after the hydraulic pressures are released.

In various embodiments, this plug-and-perf process is used to perforate and fracture a number of additional stages, e.g., stages 120B and 120C, corresponding to the horizontal portion of the wellbore 102, thus forming a number of corresponding clusters of perforation 124B and 124C and associated fractures 126B and 126C.

However, in many cases, difficulties are encountered during the hydraulic fracturing of one or more stages 120A, 120B, and/or 120C of the hydrocarbon well 100. In particular, in some cases, the proppant 128 deposits (or settles) within close proximity to the corresponding perforations or within the perforation tunnels themselves, as shown schematically in FIG. 1 with respect to the fractures 126C corresponding to the third stage 120C. In such cases, a screen out condition may occur, in which the deposited proppant 128 restricts fluid flow into the fracture(s) 126C such that continued injection of the fracturing fluid into the fracture(s) 126C would require injection pressures in excess of the safe limitations of the wellbore 102 and/or the associated wellhead equipment.

Therefore, according to embodiments described herein, a novel acid blend is flowed into the wellbore, as indicated by arrow 130, such that the acid blend is positioned within the near-perforation region of the corresponding fractures 126C that have experienced blockages or screen out conditions. As used herein, the term “near-perforation region,” wherein used in reference to a fracture within a subsurface region, refers to a portion of a fracture that is within close proximity to the corresponding perforation(s), such as, for example, within 2 feet, within 6 feet, within 10 feet, within 14 feet, within 16 feet, or within 20 feet of the perforation. In addition, the term “near-perforation region” may also refer to the actual perforations (or perforation tunnels) corresponding to the fractures.

As described further herein, the acid blend includes an acid mixture and may also include a chelating agent. The acid mixture includes hydrochloric acid and hydrofluoric acid. The chelating agent, when present, may be selected to decrease a potential for precipitation of metal ion complexes from the acid blend upon reaction of the acid blend with the formation mineralogy within the subsurface region 104. Additionally or alternatively, the chelating agent, when present, may be selected to decrease a reaction rate of the acid mixture with the formation mineralogy.

As described herein, for embodiments in which the chelating agent is included within the acid blend, the combination of hydrochloric acid, hydrofluoric acid, and the chelating agent within the acid blend may permit and/or facilitate utilization of the acid blend to mitigate wellbore screen out conditions by removing blockages within the near-perforation region of the fractures 126C without, or with a decreased potential for, precipitation of metal ion complexes from the acid solution. This decrease, or elimination, of metal ion complex precipitation may be produced and/or generated by the inclusion of the chelating agent within the acid blend and may cause the acid blends described herein to be significantly more effective when compared with conventional techniques that utilize hydrochloric acid but that do not utilize the combination of hydrochloric acid, hydrofluoric acid, and chelating agent described herein.

According to the embodiment shown in FIG. 1, the acid blend is positioned within the near-perforation region of the fractures 126C to allow the acid blend to react with and, thus, dissolve the surrounding formation mineralogies, including, for example, carbonates, clays, and/or quartz, as well as the proppant 128 that is embedded within the formation. As a result of the dissolution of such formation mineralogies, the acid blend serves to increase the hydraulic conductivity within the near-perforation region of the fractures 126C or, in other words, to decrease the resistance to fluid flow within the fractures as compared to comparable fractures that have not been exposed to, or treated with, the acid blend.

In various embodiments, the hydrocarbon well 100 also includes an acid blend supply system 132 for providing the acid blend (and/or one or more fluid streams that combine to form the acid blend) to the subsurface region 104 via the wellbore 102, such as via the tubular conduit 114 corresponding to the production casing string 112B. Specifically, in the embodiment shown in FIG. 1, the acid blend supply system 132 provides the acid blend to the wellhead 106, and the wellhead 106 then provides the acid blend to the tubular conduit 114. However, in other embodiments, the acid blend supply system 132 may provide the acid blend directly to the tubular conduit 114. Moreover, once the acid blend has been provided to the tubular conduit 114, the acid blend flows to the perforations 124C and into the near-perforation region of the corresponding fractures 126C, as indicated by the arrow 130.

In some embodiments, the acid blend supply system 132 includes a hydrochloric acid supply tank (not shown). The hydrochloric acid supply tank, when present, is configured to store, to contain, and/or to house a volume of hydrochloric acid. In addition, in some such embodiments, the acid blend supply system 132 also includes a hydrochloric acid supply conduit (not shown), which is configured to provide one or more fluid streams, which include hydrochloric acid, to the subsurface region 104, such as via the tubular conduit 114. In some such embodiments, the acid blend supply system 132 further includes a hydrochloric acid pump (not shown). The hydrochloric acid pump, when present, is configured to provide a motive force for supply of the hydrochloric acid to the subsurface region 104.

For embodiments in which the acid blend supply system 132 includes the hydrochloric acid supply tank, the hydrochloric acid supply tank may also be configured to store a volume of a chelating agent. In such a configuration, the volume of hydrochloric acid may be mixed with the volume of the chelating agent, and the mixture of the hydrochloric acid and the chelating agent may be less reactive, may be less dangerous, and/or may have a slower reaction rate when compared to a comparable volume of hydrochloric acid that is not mixed with the volume of the chelating agent. Such a configuration may cause the acid blend to be less reactive while within the wellbore 102 and/or may increase the potential for the acid blend to fully dissolve the mineralogies that are causing blockages within the fractures 126C prior to being fully reacted (or spent).

In some embodiments, the acid blend supply system 132 also includes a hydrofluoric acid supply tank (not shown). The hydrofluoric acid supply tank, when present, is configured to store, to contain, and/or to house a volume of a precursor material. The precursor material may be selected to react with hydrochloric acid to produce and/or generate hydrofluoric acid. Examples of suitable precursor material include ammonium fluoride, ammonium bifluoride, and/or a mixture of monoethanolamine and hydrofluoric acid. Additionally or alternatively, the precursor material may include and/or be hydrofluoric acid. Furthermore, in some such embodiments, the acid blend supply system 132 also includes a hydrofluoric acid supply conduit (not shown), which is configured to provide one or more fluid streams, which include the precursor material, to the subsurface region 104, such as via the tubular conduit 114. In some such embodiments, the acid blend supply system 132 also includes a hydrofluoric acid pump (not shown). The hydrofluoric acid pump, when present, is configured to provide a motive force for supply of the hydrofluoric acid to the subsurface region 104.

For embodiments in which the chelating agent is included within the acid blend, the acid blend supply system 132 may also include a chelating agent supply tank (not shown). The chelating agent supply tank, when present, is configured to store, to contain, and/or to house a volume of chelating agent. In some such embodiments, the acid blend supply system 132 also includes a chelating agent supply conduit (not shown), which is configured to provide one or more fluid streams, which include chelating agent, to the subsurface region 104, such as via the tubular conduit 114. In some such embodiments, the acid blend supply system 132 further includes a chelating agent pump (not shown). The chelating agent pump, when present, is configured to provide a motive force for supply of the chelating agent to the subsurface region 104.

It is within the scope of the present disclosure that the acid blend supply system 132 may include one or more additional pipes, conduits, valves, controllers, and/or other fluid flow-control devices that may be incorporated into the acid blend supply system 132 in any suitable manner. Such additional pipes, conduits, valves, controllers, and/or other fluid flow-control devices may be used to, for example, control and/or regulate the flow (or flow rates) of fluid streams, such as fluid streams including the hydrochloric acid, the precursor material, and/or the chelating agent, to the subsurface region 104.

Furthermore, in some embodiments, the hydrocarbon well 100 also includes a fracturing fluid supply system (not shown), which may be separate from the acid blend supply system 132 or integrated within the acid blend supply system 132 as an overall fluid supply system. In such embodiments, the fracturing fluid supply system is configured to provide a fracturing fluid and/or a slurry of fracturing fluid and proppant 128, to the subsurface region 104 via the wellbore 102, such as via the tubular conduit 114 corresponding to the production casing string 112B. Moreover, in such embodiments, the acid blend supply system 132 and the fracturing fluid supply system may be integrated such that the wellbore operator is able to selectively deliver the acid blend, the fracturing fluid, the slurry of fracturing fluid and proppant 128, and/or any other suitable fluid streams to the subsurface region 104 via the wellbore 102.

According to the embodiment shown in FIG. 1, the slurry of fracturing fluid and proppant 128 is provided (e.g., via the fracturing fluid supply system) to each individual stage 120A, 120B, and 120C of the hydrocarbon well 100 as the plug-and-perf process progresses. However, if treatment rates begin to dwindle and/or the injection pressures become exceedingly high (as is likely to be the case with respect to the fractures 126C corresponding to the third stage 120C for the embodiment shown in FIG. 1), the pumping of the slurry is paused, and the wellbore 102 may then (optionally) be flushed with a pad of fracturing fluid (e.g., slickwater). A pill of the acid blend is then injected into the wellbore 102 (e.g., via the acid blend supply system 132) such that the acid blend is delivered to the near-perforation region of the fractures 126C. In some embodiments, the pill of the acid blend is then immediately followed by another pad of the slurry such that the flow of the acid blend and the slurry through the wellbore 102 remains continuous (or nearly continuous) during the hydraulic fracturing operation. However, in other embodiments, the acid blend is allowed to react with the formation mineralogies for a certain amount of time (e.g., for at least a threshold dissolution time) to allow the acid mixture within the acid blend to dissolve the formation mineralogies that are causing the fracture blockages. At that point, the remaining acid and the resulting effluent may be displaced and flushed out of the wellbore 102 by pumping another pad of fracturing fluid, and the pumping of the slurry may then be resumed. In this manner, the acid blend described herein may be used to mitigate wellbore screen out conditions corresponding to one or more stages of the hydrocarbon well 100, thus enabling the slurry of fracturing fluid and proppant 128 to be pumped at the desired rate for the hydraulic fracturing operation.

The schematic view of FIG. 1 is not intended to indicate that the hydrocarbon well 100 is to include all of the components shown in FIG. 1, or that the hydrocarbon well 100 is limited to only the components shown in FIG. 1. Rather, any number of components may be omitted from the hydrocarbon well 100 or added to the hydrocarbon well 100, depending on the details of the specific implementation. Moreover, those skilled in the art will appreciate that, while the hydrocarbon well 100 is depicted as including only three stages 120A, 120B, and 120C, this is for case of illustration only. In practice, the hydrocarbon well 100 may include, for example, around 20 to 100 individual stages, with each stage including around 3 to 20 perforation clusters, where each perforation cluster typically includes a series of around 12 to 18 perforations extending over a 1-foot to 3-foot region, and where each zone is typically separated by around 10 to 100 feet along the length of the wellbore 102. Furthermore, those skilled in the art will appreciate that, while the hydrocarbon well 100 is depicted as including a vertical section and a horizontal section, the hydrocarbon well 100 may include any number of additional or alternative lateral, deviated, and/or highly-deviated sections extending in various directions throughout the subsurface region 104. In addition, in some embodiments, the wellhead 106 is a splitter-type wellhead that connects to a number of hydrocarbon wells 100 within the subsurface region 104.

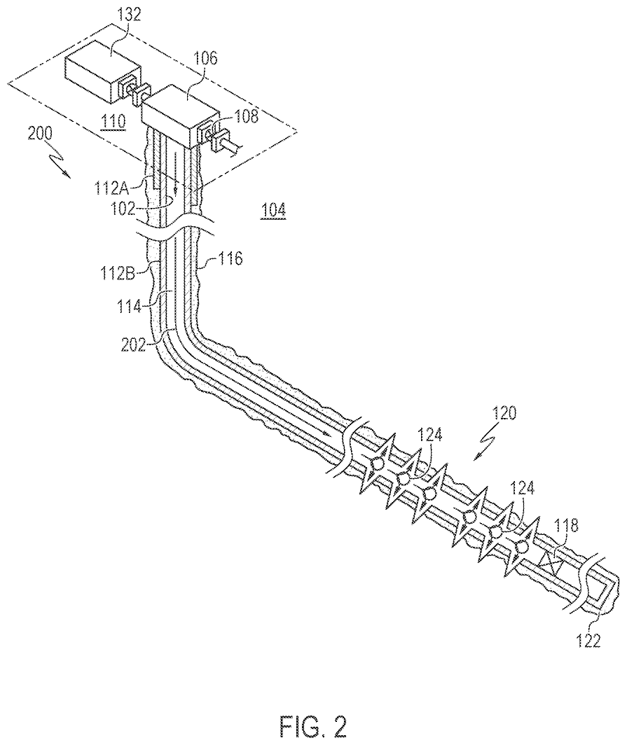

FIG. 2 is a schematic view of an exemplary hydrocarbon well 200 for which an acid blend may be used for screen out prevention according to embodiments described herein. Like numbered items are as described with respect to FIG. 1. In various embodiments, the hydrocarbon well 200 of FIG. 2 is the same as, or similar to, the hydrocarbon well 100 of FIG. 1. However, according to the embodiment shown in FIG. 2, the acid blend is used for screen out prevention, rather than screen out mitigation. More specifically, according to the embodiment shown in FIG. 2, the acid blend is used to spearhead or pre-flush the perforations corresponding to each stage of the hydrocarbon well 100 before the fractures are actually formed. For example, in various embodiments, the acid blend is provided to the clusters of perforations 124 corresponding to a stage 120 of the hydrocarbon well 100, as indicated by arrow 202 in FIG. 2. In some embodiments, the acid blend is immediately followed by another pad of the slurry such that the flow of the acid blend and the slurry through the wellbore 102 is substantially continuous. In other embodiments, the acid blend is allowed to react with the formation mineralogies for a certain amount of time (e.g., for at least a threshold dissolution time) to allow the acid mixture within the acid blend to dissolve the formation mineralogies within the near-perforation region of the formation before the pad of fracturing fluid is pumped downhole. In this manner, the acid blend described herein serves to open the perforated area wider to remove any restrictions that are likely to cause blockages as the fractures begin to form within the formation.

The schematic view of FIG. 2 is not intended to indicate that the hydrocarbon well 200 is to include all of the components shown in FIG. 2, or that the hydrocarbon well 200 is limited to only the components shown in FIG. 2. Rather, any number of components may be omitted from the hydrocarbon well 200 or added to the hydrocarbon well 200, depending on the details of the specific implementation. Moreover, those skilled in the art will appreciate that, while the hydrocarbon well 100 is depicted as including only a single stage 120, this is for ease of illustration only. In practice, the hydrocarbon well 200 may include, for example, around 20 to 100 individual stages, with each stage including around 3 to 20 perforation clusters, where each perforation cluster typically includes a series of around 12 to 18 perforations extending over a 1-foot to 3-foot region, and where each zone is typically separated by around 10 to 100 feet along the length of the wellbore 102. Furthermore, those skilled in the art will appreciate that, while the hydrocarbon well 200 is depicted as including a vertical section and a horizontal section, the hydrocarbon well 200 may include any number of additional or alternative lateral, deviated, and/or highly-deviated sections extending in various directions throughout the subsurface region 104. In addition, in some embodiments, the wellhead 106 is a splitter-type wellhead that connects to a number of hydrocarbon wells 200 within the subsurface region 104.

According to embodiments described herein, the acid blend includes the acid mixture and may also include the chelating agent, where the acid mixture includes hydrochloric acid and hydrofluoric acid. In various embodiments, performing wellbore screen out prevention and/or mitigation using an acid blend including a combination of hydrochloric acid, hydrofluoric acid, and (optionally) the chelating agent provides advantages that would not be realized using only hydrochloric acid or hydrofluoric acid separately. In particular, hydrochloric acid and hydrofluoric acid, when used separately, are typically only effective for dissolving certain formation mineralogies. As an example, hydrochloric acid is effective for dissolving formation mineralogies that include at least 80% carbonate. This may be due to the fact that, in formations that include less than 80% carbonate, metal hydroxides, such as aluminum hydroxide, may precipitate from the hydrochloric acid; and these metal hydroxide precipitates may cause an undesired decrease in fracture fluid conductivity. Conversely, hydrofluoric acid is effective for dissolving formation mineralogies that do not include carbonate. This may be due to the fact that, in formations that include carbonate, metal fluorides, such as calcium fluoride, may precipitate from the hydrofluoric acid; and these metal fluoride precipitates may cause an undesired decrease in fracture fluid conductivity.

With the above in mind, a benefit of the acid blend described herein is that the novel formulation of both hydrochloric acid and hydrofluoric acid enables the acid blend to dissolve a wider variety of formation mineralogies. Moreover, for embodiments in which the chelating agent is included within the acid blend, this may be further aided by the chelation of metal ions by the chelating agent, which decreases a potential for precipitation of metal ion complexes from the acid blend. Stated another way, the chelating agent may complex with metal ions and keep the metal ions in solution when they otherwise would form complexes that would precipitate from solution. Examples of metal ions that may be effectively maintained in solution utilizing the acid blend described herein include metal ions with a +2 charge, or more, including magnesium, calcium, aluminum, iron, and silicon ions. Examples of formation mineralogies that may be effectively dissolved by the acid blend described herein include quartz, feldspars, clays, and/or carbonates.

The acid mixture utilized in the acid blend described herein may include any suitable amount and/or proportion of acid. As examples, the acid mixture may include at least 5 wt %, at least 6 wt %, at least 8 wt %, at least 10 wt %, at least 15 wt %, at least 20 wt %, at most 35 wt %, at most 30 wt %, at most 25 wt %, at most 20 wt %, at most 18 wt %, at most 16 wt %, at most 14 wt % at most 12 wt %, at most 10 wt %, at most 8 wt %, and/or at most 6 wt % hydrochloric acid. As additional examples, the acid mixture may include at least 2 wt %, at least 3 wt %, at least 4 wt %, at least 5 wt %, at least 6 wt %, at least 8 wt %, at most 12 wt %, at most 11 wt %, at most 10 wt %, at most 8 wt %, at most 6 wt %, at most 5 wt %, and/or at most 4 wt % hydrofluoric acid. As another example, the acid mixture may include one or more additional acids in addition to the hydrochloric acid and the hydrofluoric acid.

The chelating agent, when present, may include any suitable chemical and/or compound that may be selected to decrease the potential for precipitation of metal ion complexes from the acid blend upon reaction of the acid blend with the formation mineralogy of the subterranean formation and/or that may be selected to decrease a reaction rate of the acid mixture with the formation mineralogy. As an example, the chelating agent may include and/or be an amino acid. Examples of suitable amino acids include alanine, glycine, leucine, aspartic acid, glutamic acid, arginine, and/or lysine. As another example, the chelating agent may include and/or be monoethanolamine (MEA). As another example, the chelating agent may include and/or be citric acid. As yet another example, the chelating agent may include and/or be a phosphonate. As another example, the chelating agent may include and/or be an aminopolycarboxylic acid. As additional examples, the chelating agent may include and/or be ethylenediaminetetraacetic acid (EDTA), hydroxyl ethylenediaminetetraacetic acid (HEDTA), and/or hydroxyethyl amino carboxylic acid (HACA).

Moreover, for embodiments in which the chelating agent is included within the acid blend, the acid blend may include any suitable amount and/or proportion of the chelating agent. As examples, the acid blend may include at least at least 1 wt %, at least 2 wt %, at least 4 wt %, at least 6 wt %, at least 8 wt %, at least 10 wt %, at least 15 wt %, at least 20 wt %, at least 25 wt %, at least 30 wt %, at least 40 wt %, at most 80 wt %, at most 70 wt %, at most 60 wt %, at most 50 wt %, at most 40 wt %, at most 35 wt %, at most 30 wt %, at most 25 wt %, at most 20 wt %, and/or at most 15 wt % chelating agent. As another example, each unit volume of the acid blend may include a number of moles of acidic protons and a number of moles of the chelating agent, and the number of moles of the chelating agent may be at least two times larger than the number of moles of the acidic protons. Such a configuration may permit and/or facilitate chelating of all, or of at least substantially all, metal ions released into solution during chemical interaction between the acid blend and the formation mineralogy.

It is within the scope of the present disclosure that the acid blend described herein may include and/or be a single-phase solution and/or a single-phase aqueous solution of the acid mixture and the chelating agent. Such a configuration may decrease a size and/or horsepower of pumps needed to provide the acid blend to the subterranean formation when compared to prior techniques that often involve providing fluids including two or more phases to the subterranean formation.

It is also within the scope of the present disclosure that one or more components of the acid blend may be encapsulated in a coating material and/or contained within a contained volume that is defined by the coating material. As examples, an entirety of the acid blend, the hydrochloric acid, the precursor material, and/or the hydrofluoric acid may be encapsulated in the coating material. The coating material, when present, may be configured to dissolve within a fluid that extends within the subterranean formation, such as hydrocarbon fluids. Such a configuration may decrease the potential for reaction of the acid blend with one or more other components that may be present within the subsurface region prior to the acid blend reaching the desired stage. As a more specific example, such a configuration may decrease a potential for reaction between the acid blend and metals that may form and/or define the downhole tubular of the hydrocarbon well.

In some embodiments, the acid blend includes hydrochloric acid, hydrofluoric acid, and a chelating agent in the form of lysine and/or MEA. Such a configuration also may slow a reaction rate of the acid blend, thereby decreasing a potential for reaction (or for substantial reaction) of the acid blend with fluids within the wellbore prior to reaching the desired stage.

### Experimental Data Regarding Effectiveness of Acid Blend Described Herein

The effectiveness of the acid blend described herein at increasing fracture hydraulic conductivity was demonstrated using acid etching experiments. In addition, the effectiveness of the acid blend at preventing precipitation was demonstrated using acid digestion experiments.

For the acid etching experiments, different formulations of the acid blend were pumped through several artificially-created fractures that included core samples of different compositions, and the resulting increases in hydraulic conductivity within the artificially-created fractures were then determined. More specifically, this process involved three steps. First, the initial hydraulic conductivity of each fracture was determined by measuring the ability of brine to flow through the fracture. Second, each fracture was flushed with brine; the acid blend was flowed into the fracture and allowed to react for a certain amount of time; and then the fracture was flushed with brine again. Third, the final hydraulic conductivity of each fracture was determined by measuring the ability of brine to flow through the fracture after the fracture was etched with the acid blend. The results for several different formulations of the acid blend and several different core sample compositions are shown in Table 1.

TABLE 1

| | | Composition of | | | |
|---|---|---|---|---|---|
| | | Core Sample | | Conductivity | Conductivity |
| | | Carbonate | Clay | Before Acid | After Acid |
| Acid Blend | Test | Content | Content | Etching | Etching |
| Composition | Number | wt % | wt % | μD-ft | μD-ft |
| HCl & Lysine | 1 | 9 | 12 | 5 | 8 |
| Blend | 2 | 43 | 12 | 10 | 25 |
| | 3 | 46 | 7 | 1 | 10 |
| HCl & Lysine | 1 | 17 | 18 | 4.3 | 27,000 |
| Blend + HF & | | | | | |
| MEA Blend | 2 | 5 | 27 | 0.2 | 5,736 |
| (6:1 Ratio) | 3 | 39 | 9 | 1.5 | 40,000 |
| HCl & Lysine | 1 | 41 | 11 | 2 | 80,000 |
| Blend + HF & | | | | | |
| MEA Blend | 2 | 39 | 9 | 1.1 | 1.5 |
| (12:1 Ratio) | | | | | |

As shown in Table 1, the formulation including only hydrochloric acid (i.e., in the form of the hydrochloric acid (HCl) and lysine blend) was not able to significantly increase the hydraulic conductivities within the core samples. This suggests that there was limited acid reaction with the core sample, and as a result, this particular formulation is not likely to be effective at preventing and/or mitigating wellbore blockages that typically result in screen out conditions. On the other hand, the formulation including the 6:1 ratio of hydrochloric acid (i.e., in the form of the HCl and lysine blend) and hydrofluoric acid (i.e., in the form of the hydrofluoric acid (HF) and monoethanolamine (MEA) blend) had a significant impact on the hydraulic conductivities of the core samples, regardless of the carbonate content. Surprisingly, however, the formulation including the 12:1 ratio of hydrochloric acid (i.e., in the form of the HCl and lysine blend) and hydrofluoric acid (i.e., in the form of the HF and MEA blend) had limited success. These results demonstrate that the concentrations of the hydrochloric acid and the hydrofluoric acid within the acid blend can be specifically formulated based on the formation mineralogies of interest in order to maximize the effectiveness of the acid blend at preventing and/or mitigating wellbore blockages that typically result in screen out conditions.

For the acid digestion experiments, a fixed amount of a ground and homogenized core sample was placed into a container including a specific formulation of the acid blend and then continuously stirred and heated in a roller oven for a fixed period of time. After the fixed period of time, the mixture of acid and core was removed from the roller oven; the remaining core and any precipitate were filtered out; and the solids were weighed and analyzed using X-ray diffraction (XRD) techniques, scanning electron microscope (SEM) techniques, and inductively coupled plasma (ICP) techniques. This process was performed for each of the acid blend formulations listed below in Table 2.

TABLE 2

| HCl-Based Acid | HF-Based Acid | Ratio |
|---|---|---|
| HCl & Lysine Blend | HF & MEA Blend | 5:1 |
| HCl & Lysine Blend | 36% Ammonium Fluoride | 9.9:1 |
| HCl & MEA Blend | 36% Ammonium Fluoride | 10.3:1 |

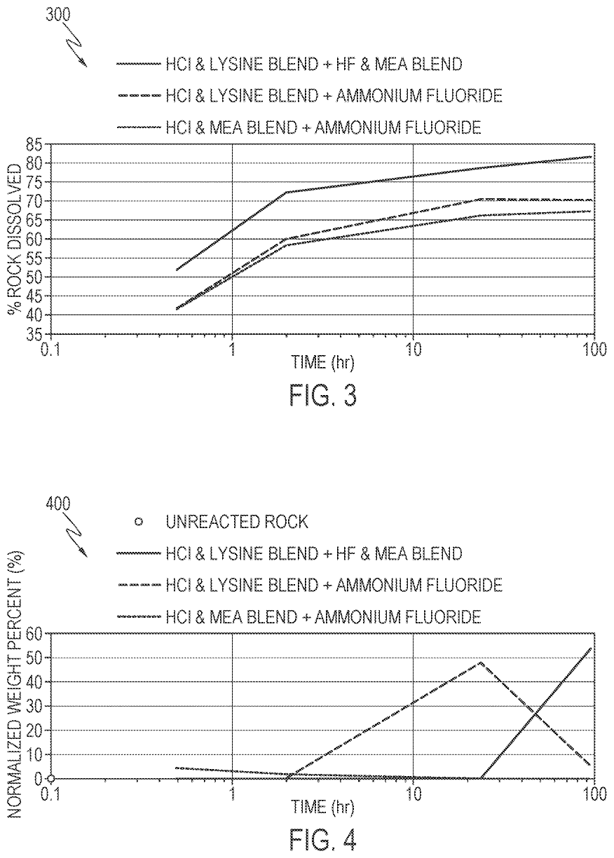

The results of the acid digestion experiments are summarized with respect to FIGS. 3 and 4. Specifically, FIG. 3 is a graph 300 showing the percentage of rock dissolved during the acid digestion experiments as a function of time for each formulation of the acid blend, which was measured based on the initial and final weights of the core sample. FIG. 4 is a graph 400 showing the normalized weight percent of the precipitate developed during the acid digestion experiments as a function of time for each formulation of the acid blend, which was measured using XRD techniques. The results shown in FIG. 3 indicate that the formulation including the 5:1 ratio of the HCl and lysine blend and the HF and MEA blend has the highest percentage of acid dissolution of the tested formulations. However, the results shown in FIG. 4 indicate that the formulation including the 10.3:1 ratio of the HCl and MEA blend and ammonium fluoride was the most effective at preventing precipitate formation. Therefore, these results further reiterate that the formulation of the acid blend described herein can be tailored to each particular implementation such that the acid blend is able to effectively dissolve the relevant formation mineralogies while also preventing precipitate formation to a suitable degree.

### Methods for Utilizing Acid Blend Described Herein for Screen Out Mitigation and/or Prevention

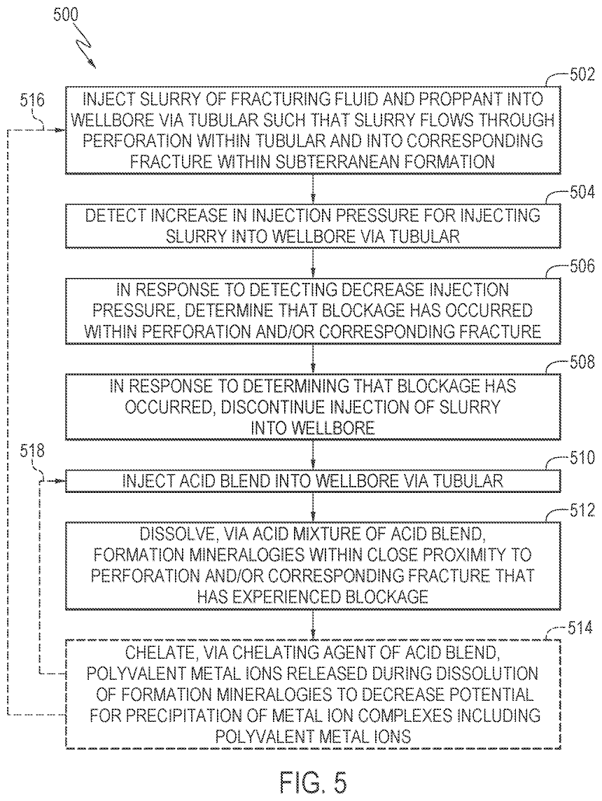

FIG. 5 is a process flow diagram of a method 500 for utilizing an acid blend to remove a blockage encountered during hydraulic fracturing of a near-wellbore region of a subterranean formation according to embodiments described herein. In particular, the method 500 may be used to mitigate screen out conditions with respect to one or more stages of a hydrocarbon well, such as the hydrocarbon well 100 described with respect to FIG. 1.

The method 500 begins at block 502, at which a slurry of fracturing fluid and proppant is injected into a wellbore via a tubular such that the slurry flows through a perforation within the tubular and into a corresponding fracture within a subterranean formation. In some embodiments, the subterrancan formation is an unconventional formation, such as a formation including, but not limited to, tight sandstone, shale, clay-rich mudstone, sand-rich mudstone, carbonate, and/or siliciclastic mudstone.

At block 504, an increase in the injection pressure for injecting the slurry into the wellbore via the tubular is detected. At block 506, in response to detecting the increase in the injection pressure, it is determined that a blockage has occurred within the perforation and/or the corresponding fracture. In various embodiments, the blockage includes proppant granules that are embedded into the perforation tunnel and/or the near-perforation region of the corresponding fracture (e.g., within 2 feet, within 6 feet, within 10 feet, within 14 feet, within 16 feet, or within 20 feet of the perforation).

At block 508, in response to determining that the blockage has occurred, the injection of the slurry into the wellbore is discontinued. In addition, in some embodiments, the wellbore is then flushed with a pad of fracturing fluid (e.g., slickwater) prior to proceeding to block 510.

At block 510, the acid blend described herein is injected into the wellbore via the tubular. As described herein, the acid blend includes an acid mixture including hydrochloric acid and hydrofluoric acid, where the hydrochloric acid comprises at least 5 wt % and at most 35 wt % of the acid blend and the hydrofluoric acid comprises at least 2 wt % and at most 12 wt % of the acid blend. In some embodiments, the acid blend also includes a chelating agent that is selected to decrease a potential for precipitation of metal ion complexes from the acid blend upon reaction of the acid blend with formation mineralogies within the subterranean formation, as well as to decrease a reaction rate of the acid mixture with the formation mineralogies. In such embodiments, the chelating agent may include at most 80 wt % of the acid blend.

In some embodiments, the method 500 also includes providing the acid blend such that the ratio of hydrochloric acid to hydrofluoric acid within the acid mixture is tailored to expected formation mineralogies to be dissolved, as described herein. Moreover, in some embodiments, the method 500 also includes providing the hydrofluoric acid of the acid mixture as a precursor material including ammonium fluoride, ammonium bifluoride, and/or a mixture of monoethanolamine and hydrofluoric acid, as well as allowing the precursor material to react with the hydrochloric acid within the acid mixture to produce the hydrofluoric acid.

At block 512, formation mineralogies within close proximity to the perforation and/or the corresponding fracture that has experienced the blockage are dissolved via the acid mixture within the acid blend. In some embodiments, this includes injecting the slurry of fracturing fluid and proppant into the wellbore immediately following the injection of the acid blend into the wellbore such that a substantially continuous flow of the acid blend through the wellbore dissolves the formation mineralogies. In other embodiments, this includes allowing the acid blend to react with the formation mineralogies for at least a threshold dissolution time. Examples of suitable threshold dissolution times include at least 5 minutes, at least 10 minutes, at least 30 minutes, at least 1 hour, at least 6 hours, at least 12 hours, at least 1 day, at least 3 days, at least 1 week, at least 2 weeks, at least 3 weeks, at least 1 month, at least 2 months, at least 3 months, at least 4 months, at least 5 months, and/or at least 6 months. Furthermore, at optional block 514, polyvalent metal ions released during the dissolution of the formation mineralogies may be chelated via the chelating agent, when present, to decrease a potential for precipitation of metal ion complexes including the polyvalent metal ions.

The process flow diagram of FIG. 5 is not intended to indicate that the steps of the method 500 are to be executed in any particular order, or that all of the steps of the method 500 are to be included in every case. Further, any number of additional steps not shown in FIG. 5 may be included within the method 500, depending on the details of the specific implementation. For example, in some embodiments, the method 500 further includes flushing the wellbore with a pad of the fracturing fluid via the tubular after the formation mineralogies are dissolved via the acid mixture (and polyvalent metal ions are chelated via the chelating agent, when present), as well as resuming the injection of the slurry into the wellbore via the tubular.

In various embodiments, the method 500 is continuously or intermittently repeated for each stage of the wellbore that experiences one or more blockages as the hydraulic fracturing operation progresses, as indicated by arrow 516. Furthermore, in various embodiments, blocks 510, 512, and (optionally) 514 are repeated a number of times for each implementation of the method 500, as indicated by arrow 518, until the formation mineralogies forming the blockage are dissolved to a suitable degree. In such embodiments, the method 500 may include flushing the wellbore with a pad of fracturing fluid via the tubular after each repetition of blocks 510, 512, and (optionally) 514 while measuring an injection pressure for injecting the pad of the fracturing fluid and, in response to detecting a decrease in injection pressure indicating that the blockage has been removed, discontinuing the repetition of blocks 510, 512, and (optionally) 514.

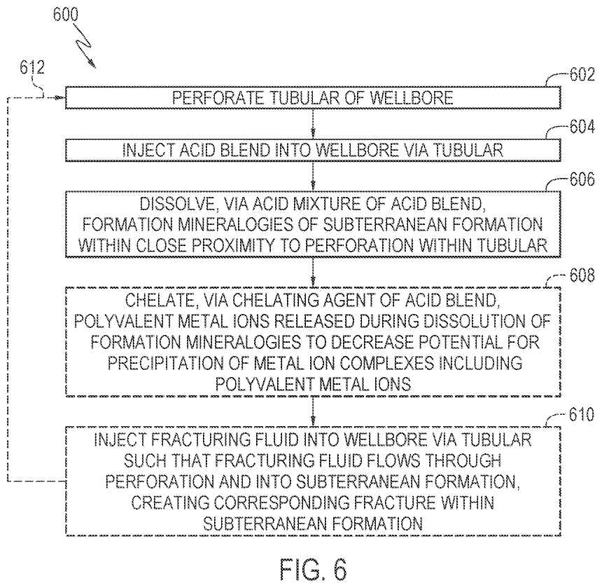

FIG. 6 is a process flow diagram of a method 600 for utilizing an acid blend to prevent a blockage during hydraulic fracturing of a near-wellbore region of a subterranean formation according to embodiments described herein. In particular, the method 600 may be used to prevent screen out conditions from occurring with respect to one or more stages of a hydrocarbon well, such as the hydrocarbon well 200 described with respect to FIG. 2.

The method 600 begins at block 602, at which a tubular of a wellbore extending into a subterranean formation is perforated, as described herein. In various embodiments, the subterranean formation is an unconventional formation, such as a formation including, but not limited to, tight sandstone, shale, clay-rich mudstone, sand-rich mudstone, carbonate, and/or siliciclastic mudstone.

At block 604, an acid blend is injected into the wellbore via the tubular. As described herein, the acid blend includes an acid mixture including hydrochloric acid and hydrofluoric acid, where the hydrochloric acid comprises at least 5 wt % and at most 35 wt % of the acid blend and the hydrofluoric acid comprises at least 2 wt % and at most 12 wt % of the acid blend. In some embodiments, the acid blend also includes a chelating agent that is selected to decrease a potential for precipitation of metal ion complexes from the acid blend upon reaction of the acid blend with formation mineralogies within the subterranean formation, as well as to decrease a reaction rate of the acid mixture with the formation mineralogies. In such embodiments, the chelating agent may include at most 80 wt % of the acid blend.

In some embodiments, the method 600 also includes providing the acid blend such that the ratio of hydrochloric acid to hydrofluoric acid within the acid mixture is tailored to expected formation mineralogies to be dissolved, as described herein. Moreover, in some embodiments, the method 600 also includes providing the hydrofluoric acid of the acid mixture as a precursor material including ammonium fluoride, ammonium bifluoride, and/or a mixture of monoethanolamine and hydrofluoric acid, as well as allowing the precursor material to react with the hydrochloric acid within the acid mixture to produce the hydrofluoric acid.

At block 606, formation mineralogies within close proximity to the perforation within the tubular are dissolved via the acid mixture within the acid blend. In some embodiments, this includes injecting the slurry of fracturing fluid and proppant into the wellbore immediately following the injection of the acid blend into the wellbore such that a substantially continuous flow of the acid blend through the wellbore dissolves the formation mineralogies. In other embodiments, this includes allowing the acid blend to react with the formation mineralogies for at least a threshold dissolution time. Examples of suitable threshold dissolution times include at least 5 minutes, at least 10 minutes, at least 30 minutes, at least 1 hour, at least 6 hours, at least 12 hours, at least 1 day, at least 3 days, at least 1 week, at least 2 weeks, at least 3 weeks, at least 1 month, at least 2 months, at least 3 months, at least 4 months, at least 5 months, and/or at least 6 months. Furthermore, at optional block 608, polyvalent metal ions released during the dissolution of the formation mineralogies may be chelated via the chelating agent, when present, to decrease a potential for precipitation of metal ion complexes including the polyvalent metal ions.

At optional block 610, fracturing fluid is injected into the wellbore via the tubular such that the fracturing fluid flows through the perforation and into the subterranean formation, creating a corresponding fracture within the subterranean formation. Moreover, as indicated by arrow 612, the method 600 may be repeated a number of times to prepare the near-perforation region of each stage of the wellbore for hydraulic fracturing.

The process flow diagram of FIG. 6 is not intended to indicate that the steps of the method 600 are to be executed in any particular order, or that all of the steps of the method 600 are to be included in every case. Further, any number of additional steps not shown in FIG. 6 may be included within the method 600, depending on the details of the specific implementation.

In one or more embodiments, the present techniques may be susceptible to various modifications and alternative forms, such as the following embodiments as noted in paragraphs 1 to 20:
1. A method for utilizing an acid blend for removing a blockage encountered during hydraulic fracturing of a near-wellbore region of a subterranean formation, comprising: injecting a slurry of fracturing fluid and proppant into a wellbore via a tubular such that the slurry flows through a perforation within the tubular and into a corresponding fracture within a subterranean formation; detecting an increase in an injection pressure for injecting the slurry into the wellbore via the tubular; in response to detecting the increase in the injection pressure, determining that a blockage has occurred within at least one of the perforation or the corresponding fracture; in response to determining that the blockage has occurred, discontinuing the injection of the slurry into the wellbore; injecting an acid blend into the wellbore via the tubular, wherein the acid blend comprises an acid mixture comprising: hydrochloric acid, wherein the hydrochloric acid comprises at least 5 weight percent and at most 35 weight percent of the acid blend; and hydrofluoric acid, wherein the hydrofluoric acid comprises at least 2 weight percent and at most 12 weight percent of the acid blend; and dissolving, via the acid mixture of the acid blend, formation mineralogies within close proximity to the at least one of the perforation or the corresponding fracture that has experienced the blockage.
2. The method of paragraph 1, wherein the acid blend further comprises a chelating agent selected to decrease a potential for precipitation of metal ion complexes from the acid blend upon reaction of the acid blend with formation mineralogies within the subterranean formation and decrease a reaction rate of the acid mixture with the formation mineralogies; and wherein the method further comprises chelating, via the chelating agent of the acid blend, polyvalent metal ions released during the dissolution of the formation mineralogies to decrease a potential for precipitation of the metal ion complexes comprising the polyvalent metal ions.
3. The method of paragraph 2, wherein the chelating agent comprises at most 80 weight percent of the acid blend.
4. The method of any of paragraphs 1 to 3, further comprising flushing the wellbore with a pad of the fracturing fluid via the tubular after discontinuing the injection of the slurry but prior to injecting the acid blend into the wellbore.
5. The method of any of paragraphs 1 to 4, wherein dissolving the formation mineralogies via the acid mixture of the acid blend comprises allowing the acid blend to react with the formation mineralogies for at least a threshold dissolution time or injecting the slurry of fracturing fluid and proppant into the wellbore immediately following the injection of the acid blend into the wellbore such that a substantially continuous flow of the acid blend through the wellbore dissolves the formation mineralogies.
6. The method of any of paragraphs 1 to 5, further comprising: flushing the wellbore with a pad of the fracturing fluid via the tubular after the formation mineralogies are dissolved via the acid mixture of the acid blend; and resuming the injection of the slurry into the wellbore via the tubular.
7. The method of any of paragraphs 1 to 6, further comprising providing the acid blend such that a ratio of the hydrochloric acid to the hydrofluoric acid within the acid mixture is tailored to expected formation mineralogies to be dissolved.
8. The method of any of paragraphs 1 to 7, further comprising repeating the injection of the acid blend into the wellbore and the dissolution of the formation mineralogies via the acid mixture of the acid blend a plurality of times.
9. The method of paragraph 8, comprising: flushing the wellbore with a pad of the fracturing fluid via the tubular after each of the plurality of times that the injection of the acid blend and the dissolution of the formation mineralogies is repeated, while measuring an injection pressure for injecting the pad of the fracturing fluid; and in response to detecting a decrease in the injection pressure that indicates that the blockage has been removed, discontinuing repeating the injection of the acid blend and the dissolution of the formation mineralogies.
10. The method of any of paragraphs 1 to 9, wherein the blockage within the at least one of the perforation or the corresponding fracture comprises proppant granules that are embedded into at least one of a perforation tunnel or a near-perforation region of the corresponding fracture.
11. The method of any of paragraphs 1 to 10, wherein the subterranean formation comprises an unconventional formation.
12. The method of any of paragraphs 1 to 11, comprising performing the method for each stage of the wellbore that experiences one or more blockages as a hydraulic fracturing operation progresses.
13. The method of any of paragraphs 1 to 12, comprising: providing the hydrofluoric acid of the acid mixture as a precursor material comprising at least one of ammonium fluoride, ammonium bifluoride, or a mixture of monoethanolamine and hydrofluoric acid; and allowing the precursor material to react with the hydrochloric acid within the acid mixture to produce the hydrofluoric acid.
14. A method for utilizing an acid blend to prevent a blockage during hydraulic fracturing of a near-wellbore region of a subterranean formation, comprising: perforating a tubular of a wellbore; injecting an acid blend into the wellbore via the tubular, wherein the acid blend comprises: an acid mixture comprising: hydrochloric acid, wherein the hydrochloric acid comprises at least 5 weight percent and at most 35 weight percent of the acid blend; and hydrofluoric acid, wherein the hydrofluoric acid comprises at least 2 weight percent and at most 12 weight percent of the acid blend; and dissolving, via the acid mixture of the acid blend, formation mineralogies of the subterranean formation that are within close proximity to the perforation within the tubular.
15. The method of paragraph 14, wherein the acid blend further comprises a chelating agent selected to decrease a potential for precipitation of metal ion complexes from the acid blend upon reaction of the acid blend with formation mineralogies within the subterranean formation and decrease a reaction rate of the acid mixture with the formation mineralogies; and wherein the method further comprises chelating, via the chelating agent of the acid blend, polyvalent metal ions released during the dissolution of the formation mineralogies to decrease a potential for precipitation of the metal ion complexes comprising the polyvalent metal ions.
16. The method of paragraph 15, wherein the chelating agent comprises at most 80 weight percent of the acid blend.
17. The method of any of paragraphs 14 to 16, further comprising, after dissolution of the formation mineralogies via the acid mixture of the acid blend, injecting a fracturing fluid into the wellbore via the tubular such that the fracturing fluid flows through the perforation and into the subterranean formation, creating a corresponding fracture within the subterranean formation.
18. The method of any of paragraphs 14 to 17, wherein dissolving the formation mineralogies via the acid mixture of the acid blend comprises allowing the acid blend to react with the formation mineralogies for at least a threshold dissolution time or injecting the slurry of fracturing fluid and proppant into the wellbore immediately following the injection of the acid blend into the wellbore such that a substantially continuous flow of the acid blend through the wellbore dissolves the formation mineralogies.
19. The method of any of paragraphs 14 to 18, comprising performing the method for at least a portion of a plurality of stages of the wellbore as a hydraulic fracturing operation progresses.
20. The method of any of paragraphs 14 to 19, further comprising providing the acid blend such that a ratio of the hydrochloric acid to the hydrofluoric acid within the acid mixture is tailored to expected formation mineralogies to be dissolved.
21. The method of any of paragraphs 14 to 20, wherein the subterranean formation comprises an unconventional formation.
22. The method of any of paragraphs 14 to 21, comprising: providing the hydrofluoric acid of the acid mixture as a precursor material comprising at least one of ammonium fluoride, ammonium bifluoride, or a mixture of monoethanolamine and hydrofluoric acid; and allowing the precursor material to react with the hydrochloric acid within the acid mixture to produce the hydrofluoric acid.

While the embodiments described herein are well-calculated to achieve the advantages set forth, it will be appreciated that such embodiments are susceptible to modification, variation, and change without departing from the spirit thereof. In other words, the particular embodiments described herein are illustrative only, as the teachings of the present techniques may be modified and practiced in different but equivalent manners apparent to those skilled in the art having the benefit of the teachings herein. Furthermore, no limitations are intended on the details of formulation, construction, or design herein shown, other than as described in the claims below. Moreover, the systems and methods illustratively disclosed herein may suitably be practiced in the absence of any element that is not specifically disclosed herein and/or any optional element disclosed herein. While compositions and methods are described in terms of “comprising” or “including” various components or steps, the compositions and methods can also “consist essentially of” or “consist of” the various components and steps. Indeed, the present techniques include all alternatives, modifications, and equivalents falling within the true spirit and scope of the appended claims.

What is claimed is:

1. A method for utilizing an acid blend for removing a blockage encountered during hydraulic fracturing of a near-wellbore region of a subterranean formation, comprising:
injecting a slurry of fracturing fluid and proppant into a wellbore via a tubular such that the slurry flows through a perforation within the tubular and into a corresponding fracture within a subterranean formation;
detecting an increase in an injection pressure for injecting the slurry into the wellbore via the tubular;
in response to detecting the increase in the injection pressure, determining that a blockage has occurred within at least one of the perforation or the corresponding fracture;
in response to determining that the blockage has occurred, discontinuing the injection of the slurry into the wellbore;
injecting an acid blend into the wellbore via the tubular, wherein the acid blend comprises an acid mixture comprising:
hydrochloric acid, wherein the hydrochloric acid comprises at least 5 weight percent and at most 35 weight percent of the acid blend; and
hydrofluoric acid, wherein the hydrofluoric acid comprises at least 2 weight percent and at most 12 weight percent of the acid blend; and
dissolving, via the acid mixture of the acid blend, formation mineralogies within close proximity to the at least one of the perforation or the corresponding fracture that has experienced the blockage.

2. The method of claim 1, wherein the acid blend further comprises a chelating agent selected to decrease a potential for precipitation of metal ion complexes from the acid blend upon reaction of the acid blend with formation mineralogies within the subterranean formation and to decrease a reaction rate of the acid mixture with the formation mineralogies; and wherein the method further comprises chelating, via the chelating agent of the acid blend, polyvalent metal ions released during the dissolution of the formation mineralogies to decrease a potential for precipitation of the metal ion complexes comprising the polyvalent metal ions.

3. The method of claim 2, wherein the chelating agent comprises at most 80 weight percent of the acid blend.

4. The method of claim 1, further comprising flushing the wellbore with a pad of the fracturing fluid via the tubular after discontinuing the injection of the slurry but prior to injecting the acid blend into the wellbore.

5. The method of claim 1, wherein dissolving the formation mineralogies via the acid mixture of the acid blend comprises:
allowing the acid blend to react with the formation mineralogies for at least a threshold dissolution time; or
injecting the slurry of fracturing fluid and proppant into the wellbore immediately following the injection of the acid blend into the wellbore such that a substantially continuous flow of the acid blend through the wellbore dissolves the formation mineralogies.

6. The method of claim 1, further comprising:
flushing the wellbore with a pad of the fracturing fluid via the tubular after the formation mineralogies are dissolved via the acid mixture of the acid blend; and
resuming the injection of the slurry into the wellbore via the tubular.

7. The method of claim 1, further comprising providing the acid blend such that a ratio of the hydrochloric acid to the hydrofluoric acid within the acid mixture is tailored to expected formation mineralogies to be dissolved.

8. The method of claim 1, further comprising repeating the injection of the acid blend into the wellbore and the dissolution of the formation mineralogies via the acid mixture of the acid blend a plurality of times.

9. The method of claim 8, comprising:
flushing the wellbore with a pad of the fracturing fluid via the tubular after each of the plurality of times that the injection of the acid blend and the dissolution of the formation mineralogies is repeated, while measuring an injection pressure for injecting the pad of the fracturing fluid; and
in response to detecting a decrease in the injection pressure that indicates that the blockage has been removed, discontinuing repeating the injection of the acid blend and the dissolution of the formation mineralogies.

10. The method of claim 1, wherein the blockage within the at least one of the perforation or the corresponding fracture comprises proppant granules that are embedded into at least one of a perforation tunnel or a near-perforation region of the corresponding fracture.

11. The method of claim 1, wherein the subterranean formation comprises an unconventional formation.

12. The method of claim 1, comprising performing the method for each stage of the wellbore that experiences one or more blockages as a hydraulic fracturing operation progresses.

13. The method of claim 1, comprising:
providing the hydrofluoric acid of the acid mixture as a precursor material comprising at least one of ammonium fluoride, ammonium bifluoride, or a mixture of monoethanolamine and hydrofluoric acid; and
allowing the precursor material to react with the hydrochloric acid within the acid mixture to produce the hydrofluoric acid.

14. A method for utilizing an acid blend to prevent a blockage during hydraulic fracturing of a near-wellbore region of a subterranean formation, comprising:
perforating a tubular of a wellbore;
injecting an acid blend into the wellbore via the tubular, wherein the acid blend comprises an acid mixture comprising:
hydrochloric acid, wherein the hydrochloric acid comprises at least 5 weight percent and at most 35 weight percent of the acid blend; and
hydrofluoric acid, wherein the hydrofluoric acid comprises at least 2 weight percent and at most 12 weight percent of the acid blend; and
dissolving, via the acid mixture of the acid blend, formation mineralogies of the subterranean formation that are within close proximity to the perforation within the tubular.

15. The method of claim 14, wherein the acid blend further comprises a chelating agent selected to decrease a potential for precipitation of metal ion complexes from the acid blend upon reaction of the acid blend with formation mineralogies within the subterranean formation and decrease a reaction rate of the acid mixture with the formation mineralogies; and wherein the method further comprises chelating, via the chelating agent of the acid blend, polyvalent metal ions released during the dissolution of the formation mineralogies to decrease a potential for precipitation of the metal ion complexes comprising the polyvalent metal ions.

16. The method of claim 15, wherein the chelating agent comprises at most 80 weight percent of the acid blend.

17. The method of claim 14, further comprising, after dissolution of the formation mineralogies via the acid mixture of the acid blend, injecting a fracturing fluid into the wellbore via the tubular such that the fracturing fluid flows through the perforation and into the subterranean formation, creating a corresponding fracture within the subterranean formation.

18. The method of claim 14, wherein dissolving the formation mineralogies via the acid mixture of the acid blend comprises:
allowing the acid blend to react with the formation mineralogies for at least a threshold dissolution time; or
injecting the slurry of fracturing fluid and proppant into the wellbore immediately following the injection of the acid blend into the wellbore such that a substantially continuous flow of the acid blend through the wellbore dissolves the formation mineralogies.

19. The method of claim 14, comprising performing the method for at least a portion of a plurality of stages of the wellbore as a hydraulic fracturing operation progresses.

20. The method of claim 14, further comprising providing the acid blend such that a ratio of the hydrochloric acid to the hydrofluoric acid within the acid mixture is tailored to expected formation mineralogies to be dissolved.

21. The method of claim 14, wherein the subterranean formation comprises an unconventional formation.

22. The method of claim 14, comprising:
providing the hydrofluoric acid of the acid mixture as a precursor material comprising at least one of ammonium fluoride, ammonium bifluoride, or a mixture of monoethanolamine and hydrofluoric acid; and
allowing the precursor material to react with the hydrochloric acid within the acid mixture to produce the hydrofluoric acid.
